(19) United States
(12) Patent Application Publication
(10) Pub. No.: US 2024/0262440 A1
(43) Pub. Date: Aug. 8, 2024

(54) Trailer with Collapsible Sides

(71) Applicant: KARAVAN TRAILERS, LLC, FOX LAKE, WI (US)

(72) Inventor: JOEL NEHRING, RANDOLPH, WI (US)

(73) Assignee: KARAVAN TRAILERS, LLC, FOX LAKE, WI (US)

(21) Appl. No.: 18/435,565

(22) Filed: Feb. 7, 2024

Related U.S. Application Data
(60) Provisional application No. 63/483,625, filed on Feb. 7, 2023.

(51) Int. Cl. B62D 63/06

(52) U.S. Cl. CPC B62D 63/061; B62D 63/062

(57) ABSTRACT

A trailer having a frame, the frame having a pair of spaced apart side frame rails, a front frame rail, and a rear frame rail, the trailer frame supports a floor panel, a longitudinally collapsible front rail attached to the front frame rail, and a pair of longitudinally collapsible, opposed side rails, each side rail being attached to a respective side frame rail, the collapsible front rail and the collapsible side rails are each pivotally coupled to at least one pivotable upstanding arm which is supported on the frame.

### RELATED APPLICATION

This application claims the benefit of provisional application Ser. No. 63/483,625 filed 7 Feb. 2023.

### BACKGROUND OF THE INVENTION

The present invention pertains to utility trailers intended to be towed by a motor vehicle. These trailers may be used for a variety of purposes including transporting luggage, materials, or sports machines. Such trailers are generally made from metal components cut to the correct length and welded together and are commonly arranged with the deck over the wheels. Such trailers must be end loaded via a ramp or the like, or otherwise materials to be loaded must be lifted over the trailer sides. The arrangement of the deck over the wheels necessitates the deck to be elevated from the ground at a height at least greater than the wheel height. In order to side load a trailer such as this, it is necessary to lift the materials onto the elevated deck. This can be impractical when loading heavy objects. Moreover, the elevated center of gravity when such a trailer is fully loaded may cause instability. Further, when such trailers include moveable sides, the sides typically pivot outwardly or inwardly of the deck, thereby interfering with deck or the exterior during loading and unloading. A new utility trailer is therefore desired which permits a lower center of gravity, having outboard wheels, with fully collapsible sides and arranged to permit facile side loading of the trailer. Such an arrangement allows the trailer to be side loaded utilizing forklifts or the like, and greatly enhances the flexibility of use. It is further desired to design a new trailer which can be side-loaded easily to reduce the logistical problems associated with side-loading trailers having an elevated, deck-over-wheels configuration.

The present invention provides a trailer having a frame, the frame having a pair of spaced apart side frame rails, a front frame rail, and a rear frame rail. The trailer frame supports a floor panel, a longitudinally collapsible front rail attached to the front frame rail, and a pair of longitudinally collapsible, opposed side rails, each side rail being attached to a respective side frame rail. The collapsible front rail and the collapsible side rails are each pivotally coupled to at least one pivotable upstanding arm which is supported on the frame. At least one of the collapsible side rails preferably includes a latch member at a distal end. The latch member is arranged to engage a corresponding bracket on an adjacent collapsible rail. The trailer further includes an axle having at least two outboard wheels arranged to support the trailer frame. Moreover, the floor panel, or deck, is supported by the frame at a position lower than the height of the wheels. The trailer may further include a bumper coupled to the rear frame rail and a hinged ramp coupled to the bumper. The trailer preferably includes means for attaching the utility trailer to a vehicle.

### BRIEF DESCRIPTION OF DRAWINGS

FIG. 1 is a perspective view of a prior art trailer.

FIG. 2 is a perspective view of a trailer according to the present invention.

FIG. 3 is a side elevation view of the trailer illustrated in FIG. 2.

FIG. 4 is a rear elevation view of the trailer illustrated in FIGS. 2 and 3.

FIG. 5 is a top view of the trailer illustrated in FIGS. 2-4.

FIG. 6 is a view similar to that of FIG. 3 but showing the side rails and front rail in collapsed position.

FIG. 7 is a view similar to that of FIG. 2 but showing the side rails and front rail in collapsed position.

FIG. 8 is an enlarged view of the area referenced as FIG. 8 in FIG. 2, and showing an upstanding pivotable arm.

FIG. 9 is an enlarged view of the area referenced as FIG. 9 in FIG. 2, and showing another view of an upstanding pivotable arm.

FIG. 10 is an enlarged view of the area referenced as FIG. 10 in FIG. 2, and showing a latch and bracket arrangement.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention which is defined by the claims.

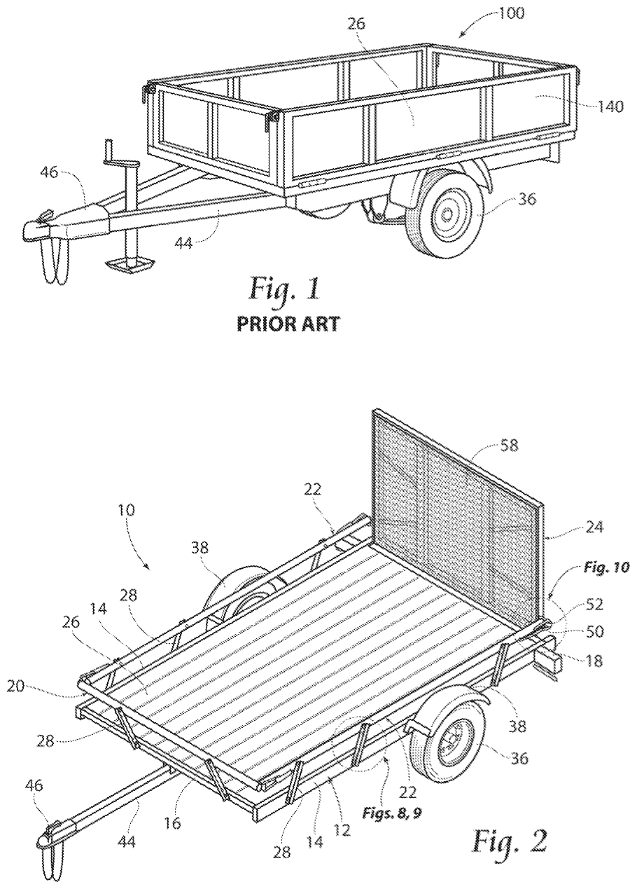

FIG. 1 illustrates a prior art trailer 100. As shown, the prior art trailer 100 includes a deck 26 positioned over the wheels 36, with the sides 140 being laterally rotatable with respect to the deck 26.

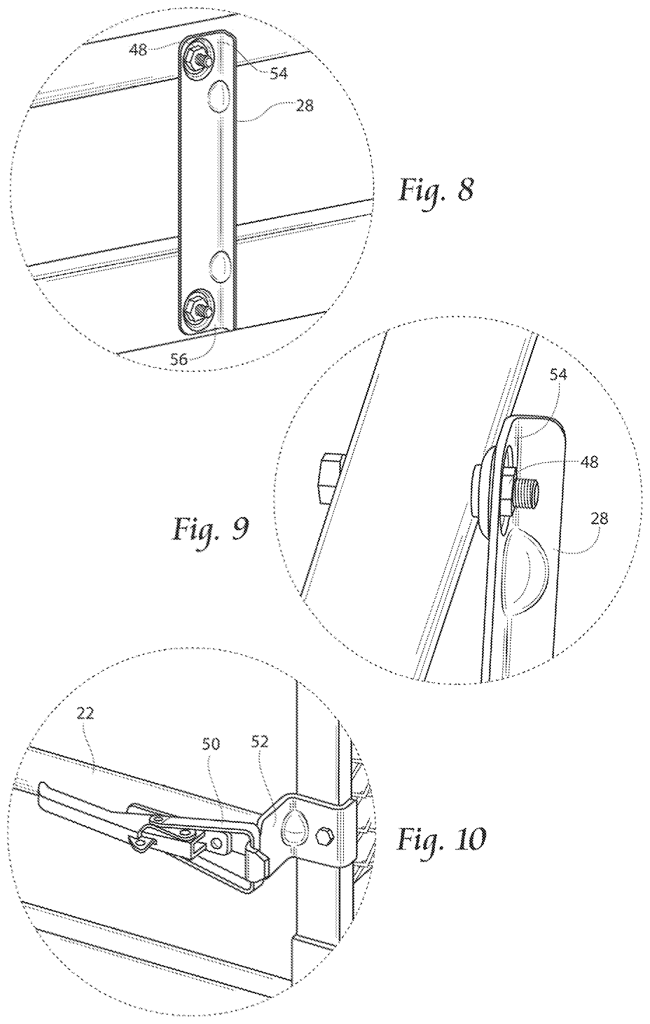

With attention to FIG. 2, a trailer 10 according to the present invention may be viewed. As seen, the trailer 10 includes a frame 12 having a pair of opposed side frame rails 14, a front frame rail 16 and a rear frame rail 18. As shown, the trailer 10 further includes a front collapsible rail 20, at least two spaced apart, opposed side collapsible rails 22, a laterally pivoting ramp 24, and a floor panel, or deck 26. The collapsible rails 22, 24 being supported on the frame 12 by way of upstanding pivoting arms 28 (see also FIGS. 8 and 9).

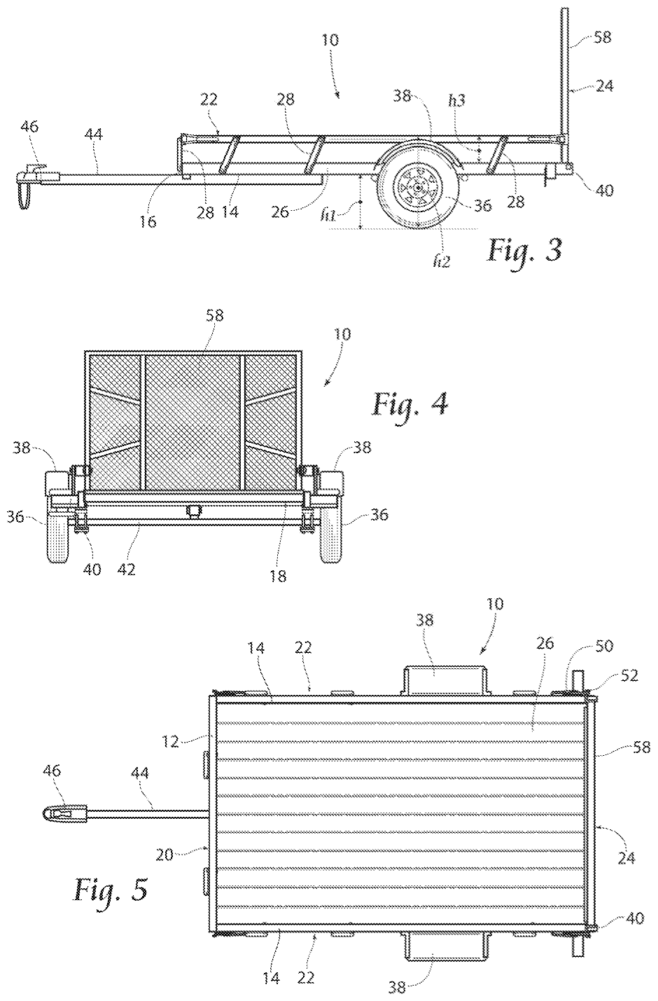

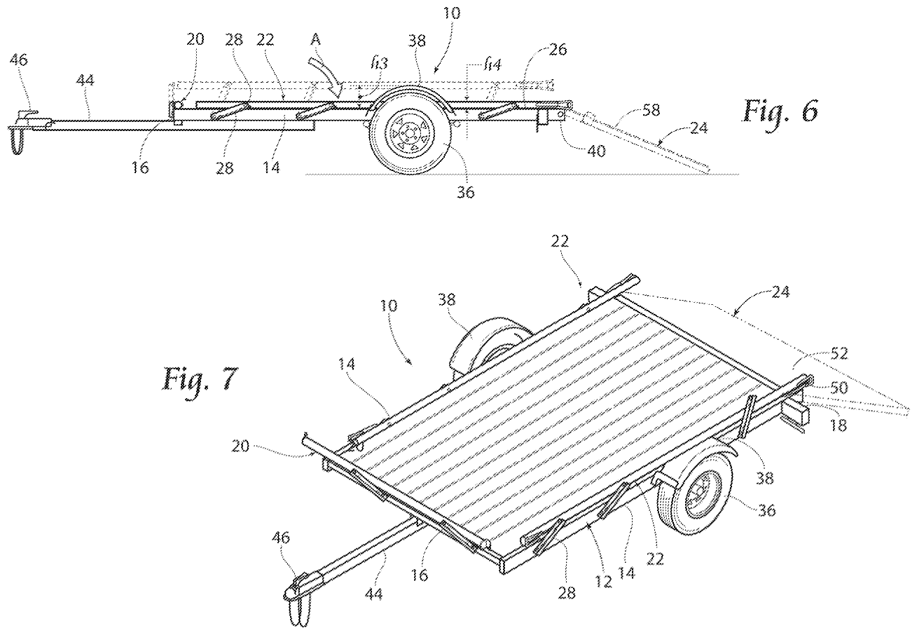

As may be seen particularly in the views of FIGS. 2 and 3, the frame 12 further supports a floor panel, or deck 26 and includes an axle 42 having at least two outboard wheels 36 arranged to support the trailer frame 12. As is shown particularly in FIG. 3, the deck 26 is supported on the frame 12 at a height h1 that is lower that the height h2 of the wheels 36 and fender 38 (if provided), such that during operation the deck 26 is positioned below the height h2 of the wheels 36. Moreover, and as mentioned, the collapsible rails 20, 22 are each preferably supported by at least one, and preferably a plurality of pivoting arms 28 such that moving the pivoting arms 28 in the direction of arrow A (see FIG. 6), moves the rails 20, 22 longitudinally from the upright position illustrated in FIG. 3, to the collapsed position illustrated in FIGS. 6 and 7.

With specific attention to FIG. 6, and as mentioned above, when the pivoting arms 28 are moved in the direction of arrow A, the rails 20, 22 are longitudinally collapsed. In this way, the rails 20, 22 are moved from an initial height of h3 above the deck 26, to a collapsed height of h4 above the deck 26. The collapsed height of h4 above the deck 26 is substantially level with the height of the deck 26 h1. As is shown, while in the collapsed position, the side rails 22 lie flat against the deck 26 at height h1, h4, and are thereby stowed for loading and unloading without interference from the wheel 36 and fender 38.

As the views of FIGS. 2 and 3 illustrate, the utility trailer 10 comprises a deck 26, with a frame 12 attachable to, and supporting the deck 26, The frame 12 includes an axle 42 (see FIG. 4) to which wheels 36, and fenders 38 if used, are attached. As mentioned, the deck 26 is positioned at a height h1 less than the height h2 of the wheel 36, such that the trailer 10 provides a lower center of gravity and better stability, in addition to ease of loading and unloading. The opposed side rails 22, are pivotally coupled to the frame 12 by way of upright members 28 such that when the upright members 28 are pivoted down to a position level with the deck 26 (see FIG. 6), the side rails 22 also longitudinally collapse to a stowed position to thereby allow material (not shown) to be easily loaded onto the deck 26. Ease of loading and unloading the trailer 10 is due in part to the longitudinally collapsible nature of the side rails 22, rather than the inwardly or outwardly pivoting of prior art sides (see FIG. 1). Further, since the collapsed height h1, h4 of the side rails 22 is less than that of the wheel 36 and fender 38 (h2, facile loading and unloading without need to elevate the material to a deck 26 height greater than that of the wheels 36, as in prior deck-over arrangements is achieved. While the Figures depict the wheels 36 having fenders 38, it is to be understood that the trailer 10 may include wheels 36 not having fenders 38 and fall within the scope of the invention.

The views of FIGS. 3, 4, and 5 illustrate the trailer 10 as further including a bumper 40, an axle 42, a tongue bracket 44 and a tongue 46. As is particularly illustrated in FIG. 3, and mentioned previously, the floor or deck 26 is positioned at a height h1 below that of the wheels 36 (h2), with an outboard arrangement of the wheels 36 as is seen particularly in FIG. 5. As mentioned, each side rail 22 is arranged to move in a longitudinal direction as its supporting pivoting arms 28 pivot.

With particular attention to FIGS. 8 and 9, it may be seen that each upstanding pivoting arm 28 includes a proximal end 54 and a distal end 56. Each of the ends 54, 56 being pivotally supported on a bolt 48, or other suitable means about which the arm 28 pivots. This arrangement allows the pivoting arms 28 to rotate about the bolt 48 such that a selected side rail 22 may move in the direction of arrow A (see FIG. 6) to lay against the deck 26, and allow the user access to the deck 26, as discussed.

With particular attention to FIG. 10, it may be seen that the rails 20, 22 may be secured in an upright position by a latch 50 and catch 52 arrangement. As shown, a catch 52 may be attached to a selected rail 20, 22, with a catch 52 attached to an adjacent rail 20, 22, or ramp 24. Movement of a rail 20, 22 on the pivoting arms 28 may be viewed in FIGS. 6 and 8. As is shown, the latch 50 is removed from the catch 52, the pivoting arms 28 rotated in the direction of arrow A, and the rail 20, 22 moves longitudinally to flatten against the deck 26. While this arrangement is shown, it is to be understood that other methods of securing and moving the rails 20, 22 may be used without departing from the invention.

In a preferred embodiment of the invention, and as mentioned, the utility trailer 10 preferably further includes means for attaching the utility trailer 10 to a vehicle (not shown) for towing. As illustrated, a tongue 44 may be secured to the trailer 10. As seen in FIGS. 2 and 3, the tongue 44 may be attached to the frame 12 in a traditional manner. The trailer 10 preferably further includes an axle 42 to support the wheels 36.

In an embodiment of the trailer 10, the rear rail 24 may be a laterally pivoting ramp 58. As is shown in FIG. 3, a ramp 58 may be attached to a rear frame rail 18 and bumper 40, and secured in its upright position by a pair of latches 50 attached to the either side of the ramp 58 and a pair of catches 52 each attached to a selected rail 22, in the manner described with regard to the rails 20, 22. While this arrangement is shown, it is to be understood that other methods of securing a pivoting ramp 58 may be used without departing from the invention.

FIGS. 4 and 5 are further views of a trailer 10 according to the present invention, and showing location of the outboard wheels 36 and optional fenders 38. FIGS. 6 and 7 illustrate a pivoting ramp 58 in a loading position wherein the latches 50 are disengaged from the catches 52 and the ramp 58 moved to the loading position shown, Although the ramp 58 illustrated in the Figures is shown as being taller than the rails 20, 22, when stowed in the upright position, it is also contemplated that the ramp 58 could be of any height and still fall within the scope of the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention which is defined by the claims.

I/We claim:

1. A trailer, said trailer having:
a frame, said frame having a pair of spaced apart side frame rails, a front frame rail, and a rear frame rail;
an axle and at least two outboard wheels supported on said frame;
a floor panel supported on said frame; and
and at least one longitudinally collapsible side rail, said at least one longitudinally collapsible side rail pivotally coupled to at least one pivotable upstanding arm, said upstanding arm being pivotally supported on said frame.

2. The trailer of claim 1 wherein said outboard wheels have a first height, said floor panel has a second height and said first height is greater than said second height.

3. The trailer of claim 2 wherein said at least one pivotable upstanding arm is movable between a first, upright position and a second, collapsed position, and when said upstanding arm is in the collapsed position said upstanding arm side rail is parallel to said frame rail.

4. The trailer of claim 3 wherein said at least one longitudinally collapsible side rail includes a latch member at a distal end.

5. The trailer of claim 1 further including a bumper coupled to said rear frame rail.

6. The trailer of claim 5 further including a hinged ramp coupled to said rear frame rail.

7. The trailer of claim 5 further including means for attaching said trailer to a vehicle.
